(19) United States
(12) Patent Application Publication
(10) Pub. No.: US 2004/0181703 A1
(43) Pub. Date: Sep. 16, 2004

(54) Selecting operation modes in electronic device

(75) Inventors: Harri Lilja, Oulunsalo (FI); Tapani Ryhanen, Helsinki (FI); Jari Vallstrom, Oulu (FI); Mika Maarala, Oulu (FI); Kai Nybacka, Ii (FI); Santtu Naukkarinen, Espoo (FI); Juha Rakkola, Espoo (FI); Petteri Jylanki, Oulu (FI)

Correspondence Address: Crawford Maunu PLLC, Suite 390, 1270 Northland Drive, St. Paul, MN, 55120, US

(73) Assignee: Nokia Corporation

(21) Appl. No.: 10/776,131

(22) Filed: Feb. 11, 2004

(30) Foreign Application Priority Data
Feb. 12, 2003 (FI) 20030213

(51) Int. Cl. H02J 7/00

(52) U.S. Cl. 713/324; 320/127

(57) ABSTRACT

The invention relates to an electronic device comprising means for controlling operation modes, one or more subunits for which, in terms of power consumption, at least two operation modes are determinable, one of the modes being an active mode and one being a sleep mode, in which sleep mode power consumption is smaller than that in the active mode. The device comprises means for measuring a movement of the device by measuring one or more movement components, the means for controlling the operation modes being configured to keep the operation mode of one or more subunits of the device as the active mode as long as the movement of the device is unknown, change the operation mode of at least one subunit of the device from the active mode to the sleep mode when the movement is identified, keep the operation mode of one or more subunits of the device as the sleep mode as long as the movement of the device is known, change the operation mode of at least one subunit of the device from the sleep mode to the active mode when the movement changes to unknown.

### FIELD

The invention relates to selecting operation modes in an electronic device.

### BACKGROUND

In devices employing accumulator and battery technology, an aim is to achieve as long an operation time as possible in order to enable a battery to be charged less often and also the life of the power source used to be extended. One of the most important ways to save power in an electronic device is to manage operation modes. As far as the operation of the device is concerned, at least two identifiable modes then exist: an active mode wherein power consumption is at a relatively high level, and a sleep mode wherein, with respect to the active mode, power consumption is at a considerably lower level. The device may be switched over to the sleep mode e.g. when the device has not been used for a certain period of time. From the sleep mode, in turn, a switch-over back to the active mode may take place when the device is used continuously, which, in the case of a computer, for example, could mean that an operational button of the computer is pressed or a mouse is moved.

In prior art solutions, a disadvantage in the optimization of the power consumption of a device is inefficiency. For example, a time threshold value determining a switch-over to the sleep mode is difficult to set so as not to make the threshold value too short for some usage situations and unnecessarily long for others.

### BRIEF DESCRIPTION

An object of the invention is to provide a method and an apparatus implementing the method so as to achieve as efficient a solution as possible for selecting operation modes in an electronic device or in a subunit of such a device. This is achieved by a method for selecting an operation mode in an electronic device comprising one or more subunits for which, in terms of power consumption, at least two operation modes are determinable, one of the modes being an active mode and one being a sleep mode, in which sleep mode power consumption is smaller than that in the active mode. The method comprises determining a movement of the device by measuring one or more movement components, keeping the operation mode of one or more subunits of the device as the active mode as long as the movement of the device is unknown, changing the operation mode of at least one subunit of the device from the active mode to the sleep mode when the movement is identified, keeping the operation mode of one or more subunits of the device as the sleep mode as long as the movement of the device is known, changing the operation mode of at least one subunit of the device from the sleep mode to the active mode when the movement changes to unknown.

The invention also relates to an electronic device comprising means for controlling operation modes, one or more subunits for which, in terms of power consumption, at least two operation modes are determinable, one of the modes being an active mode and one being a sleep mode, in which sleep mode power consumption is smaller than that in the active mode. The device comprises means for measuring the movement of the device by measuring one or more movement components, the means for controlling the operation modes being configured to keep the operation mode of one or more subunits of the device as the active mode as long as the movement of the device is unknown, to change the operation mode of at least one subunit of the device from the active mode to the sleep mode when the movement is identified, to keep the operation mode of one or more subunits of the device as the sleep mode as long as the movement of the device is known, to change the operation mode of at least one subunit of the device from the sleep mode to the active mode when the movement changes to unknown.

Some embodiments of the invention are described in the dependent claims.

The idea underlying the invention is that operation modes of an electronic device are adjusted on the basis of changes in the movement of the device. The electronic device of the invention may be e.g. a mobile phone, auxiliary equipment to be attached thereto, auxiliary equipment communicating with a mobile phone wirelessly, or a portable computer. The functionality of the invention may also be implemented in a burglar alarm or in an acceleration measurement system connectable to or contained in an electronic device. Furthermore, the device of the invention may be auxiliary equipment to be attached to a person in order to measure movement or energy consumption, such as a calorimeter or a pace counter used during exercise, or another corresponding device or a subunit of a device, such as a sensor to be attached to intelligent wear, for example.

Operation modes of a device herein refer e.g. to a normal operation mode, i.e. an active mode and a sleep mode. It is obvious that the distribution of the operation modes of a device with respect to power consumption may also be more subtle than the distribution into two different modes. In such a case, intermediate modes of power consumption, for example, may be provided between the actual active mode and the sleep mode. As far as the clarity of the description of the invention is concerned, the present invention is, however, restricted to describing the invention by means of two modes. The invention thus relates to the way in which a switch-over takes place from the active mode to the sleep mode, and vice versa, i.e. the way in which a switch-over takes place from the sleep mode to the active mode.

A switch-over from the active mode to the sleep mode can be carried out e.g. such that the movement of the device is measured in the device by means of one or more acceleration sensors. When the movement of the device in all measured directions indicates that the movement of the device has stopped, i.e. the movement of the device is known, the operation mode of the device can be changed to the sleep mode. The power consumption of the sleep mode is typically only a fraction of that of the active mode. In an embodiment, an aim is to ensure that a change in the movement of the device lasts long enough. In such a case, when it is detected that the movement of the device has stopped, a timer is started. Only when the value of the timer exceeds a threshold value set for the timer is the stopping of the movement of the device established. This ensures that the operation modes of the device do not change too frequently; too frequent changes might result in making the device difficult to use in an optimal manner.

In an embodiment, a known movement refers to the movement of a device following a movement pattern known to the device, such as a movement pattern typical of badminton or walking. Then, in the active mode, if the movement of the device corresponds with a known movement pattern, threshold values and a time window for the movement are generated on the basis of the detected movement. Threshold values refer to values within which a detected movement is still considered known. A time window refers to a time period within which a movement should recur and/or be of a certain length in order to enable the movement to be still considered known.

A sleep mode in a electronic device means e.g. that only a movement identification apparatus belonging to an acceleration subunit system of a device is in operation. Consequently, in the sleep mode, e.g. functions of the acceleration subunit system of the device actively measuring acceleration and/or a movement may be switched off. In the sleep mode, a threshold value can be set for the movement of the device and, if any one of the movement components exceeds the particular threshold value, it is established that the movement of the device has changed from motionless to moving, i.e. the movement of the device then changes to unknown. In another embodiment, the movement of the device in the active mode is compared with one or more generated threshold values and/or time windows, and if the movement remains within the threshold values and the time window, the movement can be considered known. If the movement no longer meets the criteria set for the know-ability of the movement, the movement is considered unknown and the device is brought back to the active mode.

When the movement thus changes to unknown, one or more subunits of the device may be awakened from the sleep mode to the active mode. Usually at this stage, functions of the acceleration system actively measuring acceleration and/or functions enabling an unknown movement to be identified are started. Furthermore, e.g. in the case of a mobile phone, the connection-set-up equipment of the device can be switched off in the sleep mode while in the active mode this equipment can be restored again, thus enabling a connection to a mobile telephone network to be set up again.

In an electronic device, functions used for determining a movement can be implemented in a separate acceleration measurement system. In connection with the present application, functions used for executing the rest of the functions of the device are called a main system. The functions of the invention can be divided between the acceleration measurement system and the main system in several ways. Functions that can be carried out in the acceleration measurement system and/or in the main system include, for example, measuring time by a timer and deciding the point in time at which the operation of the device is changed.

Several advantages are achieved by the method and system of the invention. When a change in the operation mode of a device depends on the movement of the device, the operation mode can be determined in a considerably more optimal manner as compared with the prior art.

### LIST OF DRAWINGS

The invention is now described in connection with preferred embodiments and with reference to the accompanying drawings, in which

FIG. 1A shows an embodiment of the method,

FIG. 1B shows another embodiment of the method,

FIG. 2 shows a mobile communication system at a general level,

FIG. 3 shows an embodiment of a mobile station,

FIG. 4 shows an embodiment of an arrangement of the invention,

FIG. 5 shows a second embodiment of the arrangement of the invention,

FIG. 6 shows a third embodiment of the arrangement of the invention,

FIG. 7 shows a fourth embodiment of the arrangement of the invention,

FIG. 8 specifies an embodiment of a measurement arrangement used for measuring a movement,

FIG. 9 describes an embodiment of a device arrangement, and

FIG. 10 shows a mechanism for identifying a movement type.

### DESCRIPTION OF EMBODIMENTS

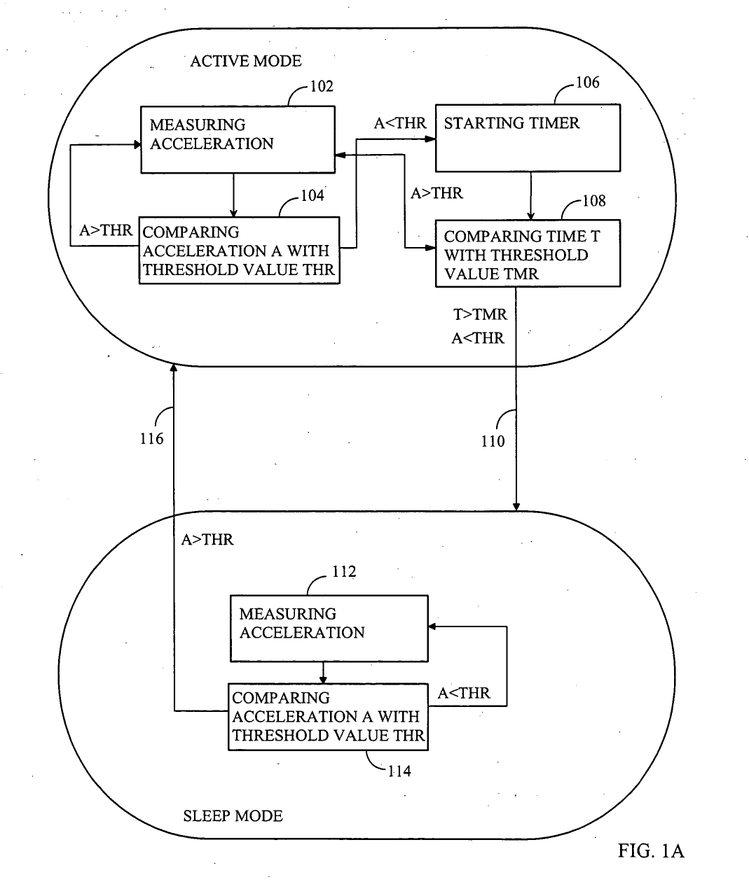

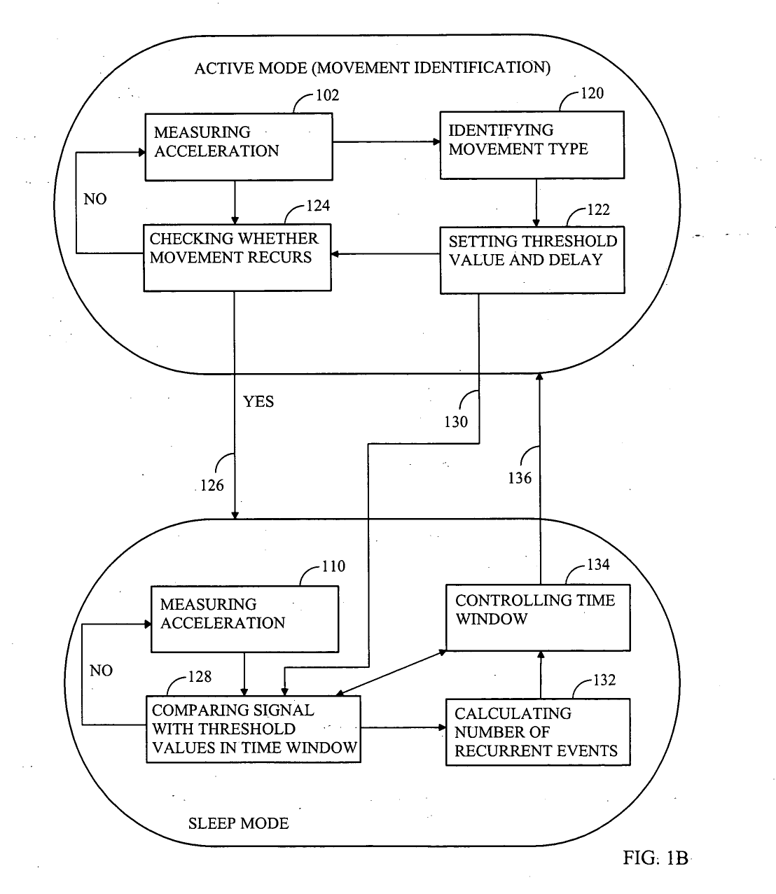

FIG. 1A shows an embodiment of a method of the invention. The method can be applied e.g. to a mobile phone, a portable computer or a burglar alarm. In terms of power consumption, operation modes can be identified in the operation of a device, two such operation modes being shown in FIG. 1A, i.e. an active mode and a sleep mode. The modes may relate to an electronic device in its entirety or only to a subunit of such a device. An active mode refers to a normal usage mode of a device wherein usage of the device or a subunit thereof is activated, and thus possible. A sleep mode, in turn, refers to a power consumption sleep mode wherein power consumption may be only fractions as compared to that of the active mode. In the sleep mode, the device is at least partly passivized, requiring a certain impulse in order for a switch-over to the active mode to be initialized.

When the device is in the active mode, acceleration is continuously measured in the device as shown by step 102. Acceleration is measured e.g. in three mutually perpendicular directions. Movement components thus measured are compared with a threshold value THR set for the acceleration. If, for at least one movement component, the acceleration remains beyond the set threshold value, the device remains in the procedures determined by steps 102 and 104. If all measured movement components fall below the determined threshold value, a timer is started as shown by step 106. In step 108, a value T of the timer is compared with a threshold value TMR set for the value of the timer. If the threshold value TMR set for the timer is met such that the threshold value THR set for the acceleration is not exceeded by any movement component during the time measurement, it can be established in the device that the movement of the device has changed, i.e. the movement of the device has stopped for a sufficient period of time. As a result of a change in the movement, the device or a subunit thereof can be switched over to the sleep mode as shown by step 110. If, during the timer measurement, any one of the movement components exceeds the threshold value set for acceleration, the process returns to step 102 to measure the acceleration determined by means of the movement components.

In the sleep mode, acceleration A is measured as shown by step 112. In step 114, acceleration is compared with the threshold value THR set for the acceleration. As long as acceleration A remains below the threshold value THR, the mode of the device remains unchanged. When the acceleration exceeds the preset threshold value, the mode of the device changes from the sleep mode to the active mode as shown by step 116. In practice, the threshold value THR describing movement is zero or at least very close to zero, which means that e.g. a change from the active mode to the sleep mode is carried out only if the device is completely motionless, and an opposite change in modes is carried out if even a slight change occurs in the movement of the device. The threshold value THR determining a stop of the movement in the active mode may be of the same magnitude as the threshold value THR determining a beginning of a movement in the sleep mode, or it may be of a different magnitude.

FIG. 1B shows another embodiment of the method. In terms of power consumption, the device has two or more operation modes. One of the operation modes is a sleep mode wherein power consumption is e.g. less than a tenth of the power consumption of one or more active modes. In the active mode of FIG. 1B, the movement of a device is unknown, i.e. the movement of the device does not follow any of the movement types entered into the device in advance. New movement types may also be identified in the device during use, i.e. a movement type does not necessarily have to be predetermined in the device. In the active mode, an aim is to identify the movement type and after the movement type has been identified, a switch-over to the sleep mode may be carried out.

In step 102 of FIG. 1B, the acceleration of the device is measured. In step 120, an aim is to identify the movement type of the device from among the measured acceleration information. Movement types may be e.g. movement types related to sports, such as movement patterns related to playing badminton or running. Movement types of a certain user may also be stored in advance in the device in specific training stages wherein, if desired, the device may be adapted to the running style of a particular user. In addition to sport-related movement types, other movement types, such as shaking, snapping or tilting, may also be stored in advance in the device.

In step 120, the comparison with the pattern example of the movement type shows that the movement type is known. In step 122, it is to be ensured that the movement type was not known by accident but that the device actually remains in the identified movement for a longer period of time. A threshold value and a delay are set for the movement. A threshold value means that a lower threshold value and/or an upper threshold value are set for a movement with respect to one or more acceleration parameters. A delay means that a certain threshold time is set during which a movement type is to recur in order to enable the movement to be established as recurrent. In an embodiment, the threshold value and the delay are set utilizing the measurement results obtained in step 120 and setting the threshold values e.g. +/−10% around the measured results. In another embodiment, the threshold value and the delay can be set user-specifically. For example, the badminton playing of a particular user may have different threshold and/or delay parameters than that of another user. In step 124, it is checked whether or not the movement recurs. This step may include a threshold value set for the number of recurrent movements. It can be thought e.g. that a certain movement should recur at least once or ten times in order for the device to establish that a certain movement type has been initiated, i.e. that the movement type has been identified. If the movement type does not recur often enough, the process returns to the initial situation 102 but, if such recurrence has been established, the operation mode of the device is changed to the sleep mode, as shown by step 126. In connection with a switch-over to the sleep mode, units of the device executing procedures required by steps 120 to 124 can be switched off.

The sleep mode remains as long as the movement of the device remains known. In the case of the embodiment described in FIG. 1B, this means that the device remains carrying out a known movement similar e.g. to walking. Even in the sleep mode, acceleration is measured in a normal manner, as shown by step 110. In step 128, acceleration signals obtained from the acceleration measurement are compared with the threshold values in a time window. The parameters used in step 128, such as a threshold value and a delay, may be the same as those used in step 122 for identifying a movement, the parameters being taken into account in connection with a change in the operation mode as shown by step 130. The threshold quantities used in steps 122 and 128 may also mutually differ in magnitude. In step 134, the measurement time window is controlled by a timer. In an embodiment, in step 132 the number of recurrent events is calculated. The calculated number of events and the parameters of a recurrent movement pattern may be utilized for estimating a derived quantity, such as the energy consumption of a user. If in step 128 it is established that the movement pattern is no longer known, i.e. it does not remain within the given parameters, a switch-over to the active mode follows again, as shown by step 136, wherein the movement pattern is to be identified again.

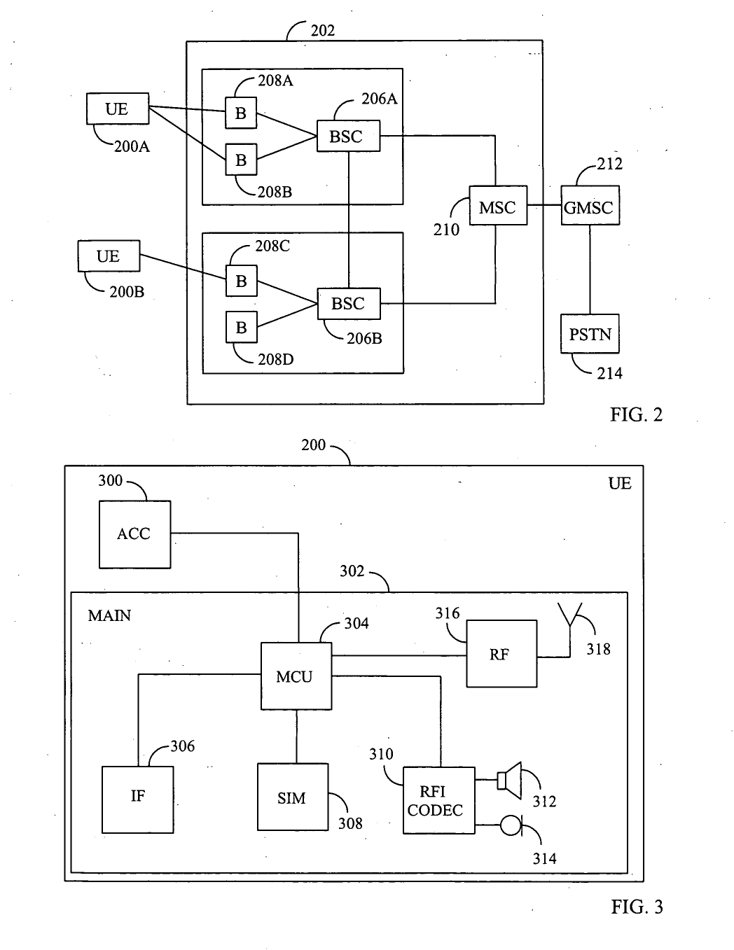

FIG. 2 describes a communication system at a high level. The communication system includes a mobile communication network 202, which is e.g. a GSM (Global System for Mobile Communications) system, but the application of the invention is by no means restricted to the particular system. The mobile communication system 202 may be connected to a fixed telecommunication network, such as a fixed telephone network PSTN (Public Switched Telephone Network) by means of a gateway center GMSC (Gateway Mobile Service Switching Center) 212. FIG. 2 further shows two terminal devices UE 200A, 200B using the mobile communication network, which may have a radio connection to one or more base transceiver stations 208A to 208D of the mobile communication network. The operation of the base transceiver stations is controlled by base station controllers 206A, 206B which, in turn, are coordinated from a mobile services switching center 210. It is obvious that the mobile communication network also includes other network elements and functions, but as far as the invention is concerned, it is irrelevant to describe them.

FIG. 3 specifies the structure of an embodiment of a mobile station 200 using the mobile communication network, the mobile station being e.g. a GSM or a UMTS (Universal Mobile Telecommunications System) mobile phone. In FIG. 3, the structure of the mobile phone is divided into two subsystems: an acceleration measurement system 300 and a main system 302. The acceleration measurement system 300 monitors the movement of the mobile station, i.e. whether the movement of the device stops in the active mode or whether the device starts to move in the sleep mode. The acceleration measurement system 300 may include one or more electromechanical acceleration sensors measuring acceleration e.g. in three orthogonal directions, each acceleration sensor being capable of measuring acceleration in one direction. The operation of an acceleration sensor may be based e.g. on a piezoelectric crystal wherein a change in charge distribution is proportional to a force directed at the crystal. Even in the case of a single acceleration sensor, the acceleration sensor may include elements that enable acceleration to be measured in more than one dimensions.

The main system 302 includes a processor 304 to execute programmatic functions of the device. The processor 304 is responsible e.g. for digital signal processing- and controlling the operation of the subunits of the device. One such subunit of the device is a user interface 306, which includes a display and a keypad of the mobile phone. The display enables visual information to be shown to a user while the keypad enables the functions of the device to be used by the user, i.e. the user may use a menu system of the device, enter textual information or set up connections to other users. The processor also checks an SIM (Subscriber Identity Module) card 308 used for identifying user information. A codec 310 of the device converts a signal supplied from the processor 304 to a form suitable for a loudspeaker 312, also converting a signal supplied from a microphone 314 to a form suitable for the processor. An RF block 316, in turn, converts a digital signal supplied from the processor 304 and to be transmitted into an analogue and radio-frequency signal in order to enable the signal to be transmitted via an antenna 318 as electromagnetic radiation. Correspondingly, the radio-frequency signal received by the antenna 318 is converted to a lower frequency and digitized in the RF block 316 prior to supplying the signal to a filter 304.

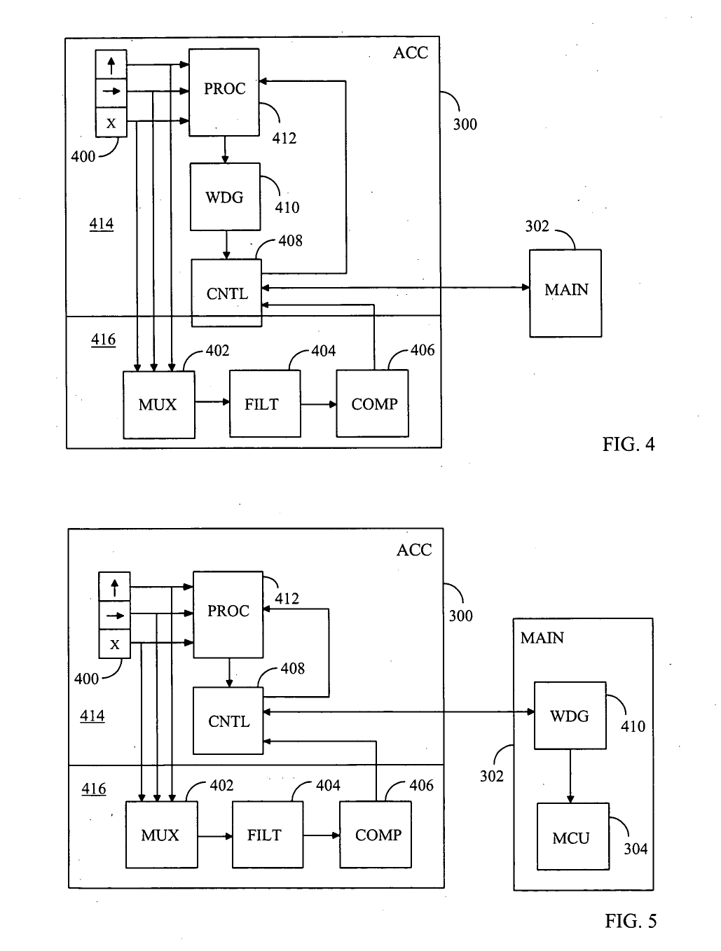

FIG. 4 describes an embodiment of an arrangement of the invention. The arrangement includes an acceleration measurement system 300 and a separate main system 302, which includes e.g. parts enabling a radio connection functionality of a mobile phone. In the solution described by FIG. 4, switching over between a sleep mode and an active mode is managed from the acceleration measurement system 300. The management of operation modes can be restricted to the acceleration measurement system 300, or commands can be transmitted from the acceleration measurement system 300 also relating to the management of operation modes of the main system 302. The acceleration subsystem 300 described in FIG. 4 may in principle carry out two opposite tasks: switching over from the active mode to the sleep mode, or vice versa, i.e. switching over from sleep mode to the active mode. The acceleration measurement system 300 can be presented as consisting of two subsystems: an acceleration measurement part 414 and a movement identification part 416. When the acceleration measurement system 300 is in the sleep mode, only the movement identification part 416 identifying movement is on. In the sleep mode, the movement of the device is measured, and if a movement starts, the actual acceleration measurement is started, i.e. the acceleration measurement part 414 is awakened from the sleep mode to the active mode. At the same time, the main system 302 of the device may be awakened if it was switched over to the sleep mode simultaneously with the acceleration measurement system 300.

The acceleration measurement system 300 includes one or more means 400 for measuring either linear or angular acceleration. The means for measuring linear acceleration may be implemented e.g. by an acceleration sensor arranged in three mutually orthogonal directions and, similarly, angular acceleration can also be measured in three mutually orthogonal directions. In addition to an acceleration signal, a rotational movement of an object may also be measured e.g. by means of a compass or a gyroscope. Acceleration sensors thus come in two types: sensors measuring linear movement and sensors measuring rotational movement. A compass based on magnetometers can also be used for measuring the rotational movement of an object, i.e. a compass signal can be used for identifying the movement of the object. In addition, gyroscopes measuring angular velocity may be suitable for the measurement. Acceleration sensors and angular velocity sensors measuring linear and rotational movement can be manufactured utilizing micromechanics production processes. Typically, magnetometers that can be used in generation of a compass functionality are magnetoresistive, magnetoinductive, Hall or Fluxgate sensors.

The acceleration measurement system 300 also includes means 412 for processing measurement results. The measurement results are forwarded to means 410 for comparing the measurement results with a predetermined threshold value. The threshold value is set low enough such that when values measured by acceleration sensors 400 reside below the threshold value, the movement of the device can be considered to have stopped. The comparison means 410 can be used for informing a control unit 408 that movement components have dropped below the threshold value. In an embodiment, the control unit 408 starts a timer, and on the basis of a measurement carried out by the timer, it is estimated whether or not the movement of the device has stopped for a sufficiently long period of time. If the timer to be started for time measurement reaches a preset threshold value and if, during the time measurement, the movement components remain below the threshold value set for acceleration, the control unit 408 establishes that the movement of the device has stopped. As a result, the control unit 408 issues a command to switch over subunits of the device from the active mode to the sleep mode. The command to switch modes can be transmitted e.g. to the acceleration measurement part 414 of the acceleration measurement system 300 and/or to the main system 302 of the device which, in the case of a GSM phone, for example, could refer to device components implementing network connections. The GSM phone could then enter into a mode wherein it has no active connection to the mobile communication network.

When in the solution of FIG. 4 the mode has been switched over to the sleep mode, the operation of the system continues such that in the sleep mode, the movement identification system 416 is active, monitoring changes in the movement of the device. Measurement results measured by the acceleration sensors 400 are delivered to a multiplexer 402, which selects the highest from among the measurement results and supplies the value as its output to filtering means 404. The filtering means filter potential interference components from the measurement result and remove e.g. the effect of earth gravity from the measurement results. The filtered measurement result is delivered to comparison means 406, which compare the measurement result of the acceleration sensors with a predetermined threshold value. In practice, the value of the predetermined threshold value is very small, which enables a beginning of a movement of a device connected to the acceleration measurement system 300 to be detected. If the threshold value is exceeded, the comparison means inform the control unit 408 that the threshold value has been exceeded. The control unit 408 can, on the basis of the received information, bring the mode of one or more subsystems of the electronic device from the sleep mode to the active mode. The command to switch modes can be issued e.g. to the acceleration measurement system 414 or to the main system 302 of the device. The solution described by FIG. 4 can then be used e.g. as a burglar alarm, wherein when the movement of the device starts, the device connects to a mobile communication network and automatically gives an alarm, further enabling the device that gave the alarm to be located within the mobile communication network.

It can be seen in FIG. 4 that the movement identification part 416 and the acceleration measurement part 414 utilize the same acceleration sensors 400 in their measurements. This enables the acceleration sensors 400 to be utilized in an efficient manner and cost-effective solutions to be used.

FIG. 5 describes a second embodiment of the arrangement of the invention. As compared to FIG. 4, the most important difference is that a switch-over to the sleep mode is controlled in the main system 302 of the device. A switch-over from the active mode to the sleep mode mainly takes place such that the acceleration measurement system 300 generates an acceleration sensors measurement result which, by the control unit 408, is delivered to the comparison means 410 located in the main system of the device, the comparison means starting a timer when, on the basis of a comparison with a threshold value, it is detected that the movement of the device has stopped. If the time measured by the timer exceeds the preset threshold value and the device remains motionless during the entire measurement time, the comparison means 410 informs the main processor 304 of the device and the control unit 408 of the acceleration measurement system 300 of this. The processor 304 is responsible for turning off subunits of the device, such as a GSM engine and a display, when the device switches over to the sleep mode. The control unit 408 of the acceleration measurement system 300, in turn, turns off the functions of the acceleration measurement system 300 e.g. such that only the movement identification subsystem 416 remains in the active mode wherein it is capable of detecting when the device starts moving again. When such a movement is detected again, the functions of the acceleration measurement system actively measuring acceleration are started again. In other words, detecting movement in the device is simpler in the sleep mode than what it is in the active mode which, among other things, includes monitoring the magnitude of accelerations.

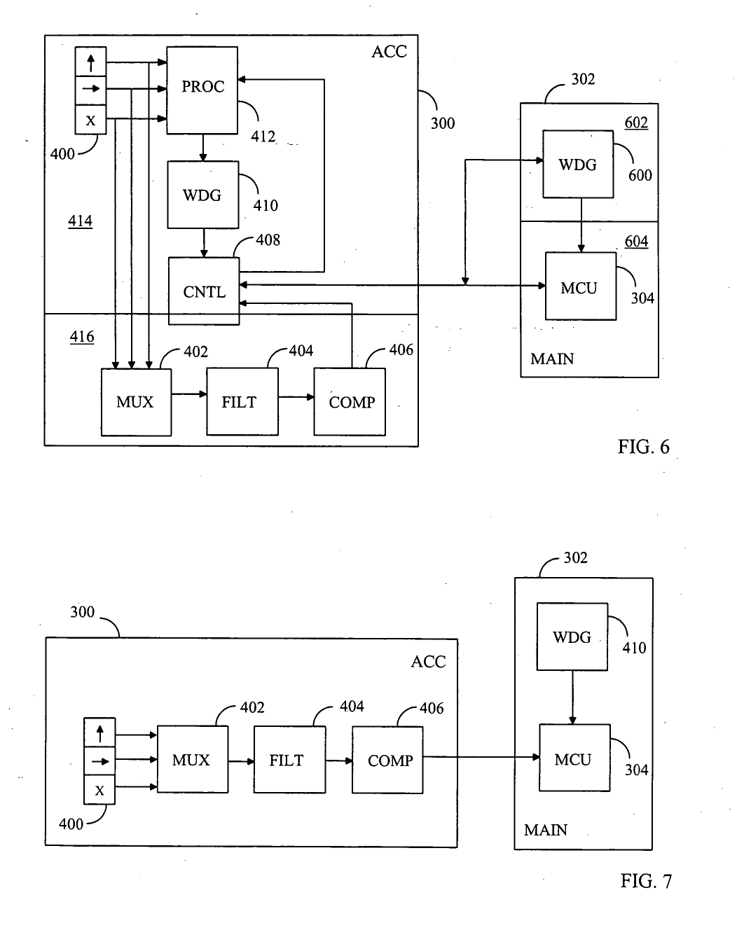

FIG. 6 describes still another embodiment of the invention. In this embodiment, the operation modes of the acceleration measurement system 300 are controlled on the basis of measurements taking place in the acceleration measurement system 300 itself. In other words, acceleration measurement data is compared with a threshold value in the comparison means 400, and if the movement of the device stops for a sufficiently long period of time, the control means issue a command to the processing unit 412 to switch over to the sleep mode. The movement measurement subsystem 416, however, remains in the active mode, measuring continuously whether or not the movement of the device and/or the acceleration measurement system starts again. The data measured by the measurement sensors is also delivered to the main system 302, which includes comparison means 600 of its own for detecting an end and/or a beginning of a movement. The main system 302 is thus capable of independently deciding when the main system is kept in the active mode and when it is switched over to the sleep mode. As to the main system 302, a movement identification subsystem 602 is kept active also in the sleep mode while a subsystem 604 including the main processor 304 is turned off.

FIG. 7 shows still another embodiment of the invention, wherein the acceleration measurement system 300 is used in the detection of a beginning of a movement, in which case the solution can be used e.g. in a burglar alarm. In the embodiment described by FIG. 7, the device includes no actual active mode acceleration measurement at all but only movement measurement means of a simpler kind. Information measured by the acceleration sensors 400 is conveyed to the multiplexer 402, which enables different measurement directions (x, y, z) to be successively measured by using the same electronics. In other words, the multiplexer takes samples from the sensors e.g. at a frequency of 1200 Hz, which would thus give samples from each measurement direction at a frequency of 400 Hz. The system thus allows the movement of directions x, y, z to be measured successively. The direction of the movement information is not necessarily distinguished in the sleep mode. When the movement exceeds the threshold value in one direction, the system outputs a signal of the form of a pulse. In multiplexing, it may also be an objective to detect the direction of the movement, i.e. in such a case a 6-bit output signal could indicate acceleration direction +/−x, +/−y, +/−z. The signal obtained from the multiplexer 402 is filtered and compared with a preset threshold value in the comparison means 406. If the result of the comparison shows that the electronic device to which the acceleration measurement system 300 belongs moves, the main system 302 is informed that the movement has started, and the main system is thus again awakened to the active mode. The data transferred between the acceleration measurement system 300 and the main system can be in a digital form, in which case a bit ‘0’ is transferred to the main system e.g. at certain intervals if the device is motionless and, correspondingly, a bit ‘1’ if the device is moving. The comparison means 410 located in the main system then monitors the received bits and, on the basis thereof, concludes the movement and, when necessary, starts time measurement. The solution described by FIG. 7 can thus be used both for awakening and passivizing the main system 302.

The above figures show some embodiments of the invention. The figures describe solutions wherein the acceleration measurement system is provided with a sleep mode of its own, which means that the movement identification part belonging to the acceleration subsystem is, however, active, measuring when the movement starts again. The figures show several solutions for positioning the control necessary for switching modes. The operation modes of the acceleration measurement arrangement can be controlled from the acceleration measurement system or from the main system. Similarly, the modes of the main system can be controlled from the acceleration measurement system or from the main system. The information transferred between the acceleration measurement system and the main system consists e.g. of acceleration measurement data, digital data describing a movement or commands to change a current operation mode. In a similar manner to that in the acceleration measurement system, in the main system the movement identification and comparison means may also be active in the sleep mode as well. In other words, in the described solutions even though one subsystem is switched over to the sleep mode, not absolutely all functions of the particular subsystem are, however, necessarily turned off, not even in the sleep mode.

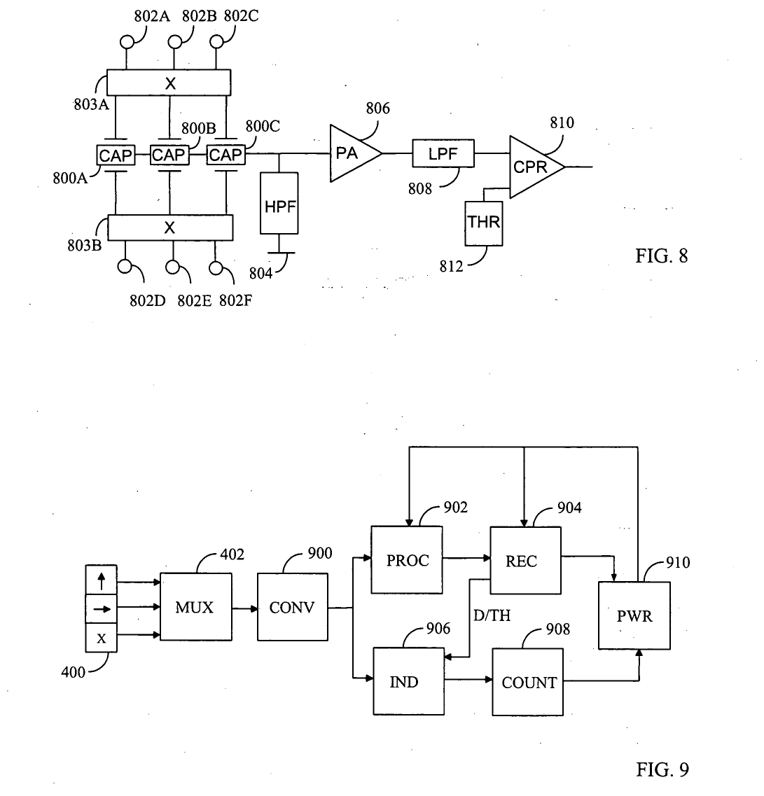

FIG. 8 shows by way of example one embodiment of acceleration sensors, i.e. the sensor solution described in the device solutions is specified. The sensor arrangement includes capacitive sensors 800A to 800C arranged with respect to each other such that each sensor detects movement taking place in mutually different directions. Either a positive (802A, 802D) or a negative (802B, 802E) supply voltage or ground potential (802C, 802F) can be coupled to the sensors 800A to 800C. Coupling the voltages in a correct sequence to the sensors 800A to 800C enables a movement sensor to be made sensitive to a particular direction. For example, by coupling a positive voltage to a first electrode of the sensor 800A and a negative voltage to a second electrode as well as by coupling the sensors 800B and 800C to the ground potential, it is possible to measure the characteristic direction of the sensor 800A, which characteristic direction is typically orthogonal with the characteristic directions of the sensors 800B and 800C. All three characteristic directions can be selected in a sequence in a similar manner. By coupling different combinations it is possible to change the sensitivity direction of a sensor to a desired, arbitrary direction by simultaneously adjusting the value of the voltage or the length of voltage pulses.

The obtained signal is filtered and amplified by a high-pass filter 804, an amplifier 806 and a low-pass filter 808. The signal thus processed is conveyed to a comparator 810 which, as its input, receives a reference voltage level 812 also to be used as a threshold value. If the signal obtained from the sensors exceeds the reference voltage level, the sensor arrangement outputs a signal which indicates that the threshold value has been exceeded.

In practice, the same coupling may also be used for measuring acceleration signals in a more accurate manner. A known way is to implement the measurement as a coupling of the charge amplifier type. The point in this invention is that different modes of the same electronics enable active mode and sleep mode measurements to be implemented. In the active mode, measurement electronics measure capacitance values from sensors while in the sleep mode the measurement electronics detect a potential change in the capacitance by the sensors. Several different realisations are known for a coupling matrix and the implementation of the electronics.

In the solution of FIG. 8, in addition to a threshold value and a delay, a direction to be monitored can be selected, i.e. trained, for the device also on the basis of an accurate measurement involving a larger number of axes. In such a case, if the movement takes place with respect to the sensor 800A, for example, the measurement can be focused to listen to a change in the capacitance in the sensor 800A. In principle, it is thus possible to maximize the magnitude of a recurrent signal by selecting the optimal direction.

FIG. 9 shows an embodiment of the device arrangement. The device includes means 400 for measuring acceleration. The measurement means ca be implemented e.g. by sensors measuring linear or angular acceleration, magnetometers or gyroscopes. The technical implementation of the sensors may be based e.g. on detecting a change in the capacitance caused by acceleration. The multiplexer 402 selects the direction of the acceleration, which is conveyed to conversion means 900. Different acceleration directions are measured in successive order. The conversion means convert an input signal indicating a capacitive change into voltage or current. Next, the produced signal is processed in processing means 902, wherein the received signal is subjected e.g. to an A/D conversion, filtering and calibration. A digital signal is given as the output, the resolution of the signal being e.g. 8 to 15 bits.

The generated signal is used in means 904 for identifying a movement type. The movement type identification means 904 identify the movement type by comparing the measurement data with the movement type patterns stored in advance. If, on the basis of the measurement data, a movement type can be established to be actualized, threshold values TH and movement recurrence delay parameters D proportioned to the measurement data are generated and delivered to threshold value comparison means 906. The movement type identification means 904 are connected to means 910 for managing operation modes. When the movement type of the device is identified in the active mode, a command to switch over to the sleep mode can be issued from the operation modes management means 910 e.g. to the processing unit 902 and the identification means 904.

Both in the active mode and in the sleep mode, the comparison means 906 monitor whether or not the movement stays within the given threshold values. In the sleep mode, the comparison means cooperate with calculation means 908. The calculation means 908 calculate the number of recurrent movement events, and may also monitor the recurrence frequency of the recurrent events. If an average recurrence frequency exceeds the given limits, the calculation means transmit a signal to power control means 910, which awaken the movement type identification means 904 and the processing means 902 to the active mode again. The calculation means 908 can, on the basis of the number of movement events and intensity, also calculate derived quantities, such as the energy consumption of a user or a distance walked by a user. It is obvious that also other variables, such as the weight of a user, may also be used in the calculation of derived quantities. The value of a calculated derived quantity can be shown on the display of the device.

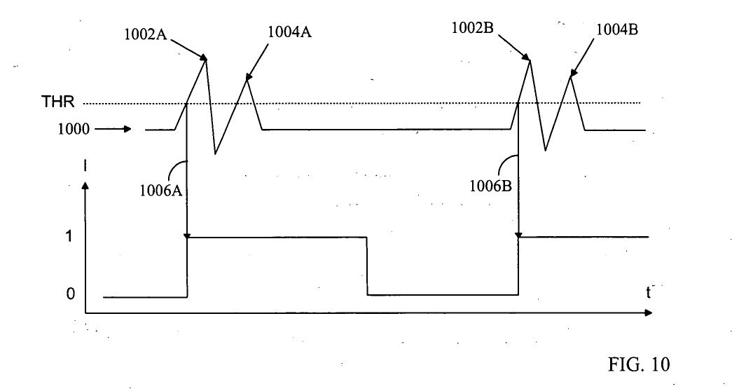

FIG. 10 describes a mechanism which enables the number of spurious mode switching events to be reduced in an electronic device. It is assumed that the device is in the sleep mode, monitoring whether a certain movement recurs at certain intervals. In FIG. 10, the measured acceleration data is described by curve 1000, the data being compared with a threshold value THR. At point 1006A, the value of an acceleration signal exceeds the threshold value THR, eventually reaching a peak value 1002A. Software controlling mode switching regards a first exceeding of a threshold value as a desired and monitored exceeding and, as shown by the coordinates at the bottom of FIG. 10, interruption I of the device is activated. The idea of the interruption is actually to keep the main system MCU in the sleep mode, wherefrom it can be awakened by an interruption. Next, the main system may read the actual cause of the interruption from a register, i.e. the first exceeding of the threshold value and other movement events possibly registered after that, such as exceedings or maximums of limit values occurred in other channels (x, y, z) after the first movement. This information is acknowledged to be processed from the main system level by acknowledging the interruption, whereafter the measuring device remains detecting the next movement event while the main system is in the sleep mode, except for the interruptions processing routine. A new event then results in a new interruption but only after the previous one has been acknowledged. An interruption may also be used for calculating the number of exceedings of limit values (movements) if the interruptions processing routine in the main system includes the particular calculation function, or an interruption may be used for measuring the time between movement events. The main system may adjust the delay between detecting successive events by adjusting the time from an interruption to an acknowledgement of the interruption. It is possible to allow and prevent interruptions of different measurement channels channel-specifically.

Referring to FIG. 10, since the interruption is active after the peak 1002A, the next events exceeding the threshold value are interpreted to be spurious events, and they are filtered off. This is what happens e.g. to a signal peak 1004A measured in movement data. After a preset period of time has elapsed, the interruption is passivized. The interruption is activated again at a next event 1006B exceeding the threshold value. The peak value 1002B is thus considered to be a desired event and, as in the previous case, the undesirable signal peak 1004B is filtered off.

In addition to the components shown in the figures, the inventive characteristics can be implemented in an electronic device e.g. by software, as an ASIC (Application Specific Integrated Circuit) or by separate logic components.

Although the invention has been described above with reference to the example according to the accompanying drawings, it is obvious that the invention is not restricted thereto but can be modified in many ways within the scope of the attached claims.

1. A method for selecting an operation mode in an electronic device comprising one or more subunits for which, in terms of power consumption, at least two operation modes are determinable, one of the modes being an active mode and one being a sleep mode, in which sleep mode power consumption is smaller than that in the active mode, the method comprising:
determining a movement of the device by measuring one or more movement components;
keeping the operation mode of one or more subunits of the device as the active mode as long as the movement of the device is unknown;
changing the operation mode of at least one subunit of the device from the active mode to the sleep mode when the movement is identified;
keeping the operation mode of one or more subunits of the device as the sleep mode as long as the movement of the device is known; and
changing the operation mode of at least one subunit of the device from the sleep mode to the active mode when the movement changes to unknown.

2. The method of claim 1, wherein the movement is known when the device is motionless.

3. The method of claim 2, wherein when the value of the movement component is below a predetermined threshold value, the method further comprises:
starting time measurement, and
changing the operation mode of at least one subunit of the device from the active mode to the sleep mode if the time measurement exceeds a predetermined threshold value set for the time measurement, the movement of the device then being considered motionless.

4. The method of claim 1, wherein the movement is unknown when the device moves.

5. The method of claim 4, wherein a beginning of the movement of the device is detected by comparing the value of the movement component with the predetermined threshold value.

6. The method of claim 1, wherein the movement is known when the movement of the device corresponds with a predetermined movement type.

7. The method of claim 6, wherein when the movement corresponds with the predetermined movement type, for measurements to be carried out in the sleep mode the method comprises:
setting a threshold interval for the value of one or more movement components, within which threshold interval the value is to remain,
setting a time window for the movement type, during which time window the movement type is to recur,
whereby the movement of the device is considered known when the value of one or more movement components resides within the threshold interval and the movement type recurs within the set time window.

8. The method of claim 6, wherein when the movement of the device is known,
the value of one or more movement components recurrently exceeds the preset threshold value within the predetermined time window.

9. The method of claim 8, wherein when the value of the movement component exceeds the predetermined threshold value, the method comprises:
setting a guard period within the time window, exceedings of the threshold value occurring within the guard period being filtered off.

10. The method of claim 6, wherein in the sleep mode, when the movement of the device corresponds with the predetermined movement type, the method comprises:
calculating the number of recurrence of the movement type,
using the calculated number for calculating a derived quantity.

11. The method of claim 6, wherein after the movement type has been identified, one or more movement components most appropriately characterizing the movement type is/are selected from among one or more movement components to be measured, the movement being monitored with respect to such a movement component or such movement components in the sleep mode.

12. The method of claim 1, wherein the movement is unknown when the movement of the device does not correspond with the predetermined movement type.

13. The method of claim 1, wherein one or more movement components to be measured in the measurement of the movement of the device belong to one of the following groups: one or more linear acceleration components, one or more angular acceleration components, one or more magnetic field components, one or more angular velocity components.

14. The method of claim 1, wherein one or more movement components are measured by one or more movement sensors, the same movement sensors being used both in the active mode and in the sleep mode.

15. The method of claim 1, wherein when the operation mode of the device changes from the active mode to the sleep mode, functions necessary for identifying a movement in the device are turned off.

16. The method of claim 1, wherein when the operation mode of the device changes from the sleep mode to the active mode, functions necessary for identifying a movement in the device are turned on.

17. An electronic device comprising:
means for controlling operation modes;
one or more subunits for which, in terms of power consumption, at least two operation modes are determinable, one of the modes being an active mode and one being a sleep mode, in which sleep mode power consumption is smaller than that in the active mode, wherein the device comprises:
means for measuring a movement of the device by measuring one or more movement components, the means for controlling the operation modes being configured to:
keep the operation mode of one or more subunits of the device as the active mode as long as the movement of the device is unknown;
change the operation mode of at least one subunit of the device from the active mode to the sleep mode when the movement is identified;
keep the operation mode of one or more subunits of the device as the sleep mode as long as the movement of the device is known;
change the operation mode of at least one subunit of the device from the sleep mode to the active mode when the movement changes to unknown.

18. The device of claim 17, wherein the movement is known when the device is motionless.

19. The device of claim 17, wherein the movement is unknown when the device moves.

20. The device of claim 18 or 19, wherein the device is configured to detect that a movement stops and/or starts by comparing the value of the movement component with a preset threshold value.

21. The device of claim 17, wherein the movement is known when the movement of the device corresponds with a predetermined movement type.

22. The device of claim 21, wherein the device comprises:
means for setting a threshold interval for the value of one or more movement components, within which threshold interval the value is to remain,
means for setting a time window for the movement type, during which time window the movement type is to recur,
means for comparing, in the sleep mode, one or more values of the movement component with the threshold interval and the recurrence of the movement type with the length of the time window, the control means being configured to treat the movement of the device as known when the value of one or more movement components resides within the threshold interval and the movement type recurs within the set time window.

23. The device of claim 21, wherein the device comprises:
means for calculating the number of recurrence of the movement type in the sleep mode when the movement of the device corresponds with the predetermined movement type, and
means for calculating the value of a derived quantity on the basis of recurrent movement types.

24. The device of claim 17, wherein the movement is unknown when the movement of the device does not correspond with the predetermined movement type.

25. The device of claim 17, wherein one or more measurement means of the movement belong to one of the following groups: one or more linear acceleration sensors, one or more angular acceleration sensors, one or more magnetometric sensors, one or more gyroscopic sensors.

26. The device of claim 17, wherein the means for measuring the movement consist of one or more acceleration sensors and the device is configured to use the same acceleration sensors both in the active mode and the sleep mode.

27. The device of claim 17, wherein the control means are configured to consider the movement of the device known when
the value of one or more movement components exceeds a preset threshold value within the predetermined time window.

28. The device of claim 27, wherein when the value of the movement component exceeds the predetermined threshold value, the control means are configured to set a guard period within the time window and to filter off exceedings of the threshold value occurring within the guard period.

29. The device of claim 17, wherein the control means are configured to select one or more movement components most appropriately characterizing the movement type from among one or more movement components to be measured, the movement being examined with respect to such a movement component or such movement components in the sleep mode.

30. The device of claim 17, wherein the control means are configured to turn off one or more subunits in the device necessary for identifying a movement when the operation mode of the device changes from the active mode to the sleep mode.

31. The device of claim 17, wherein the control means are configured to turn on one or more subunits necessary for identifying a movement when the operation mode of the device changes from the sleep mode to the active mode.

32. The device of claim 17, wherein the device comprises:
means for measuring time if the movement measurement in the active mode indicates that the movement of the device is known, the control means being configured to
change the operation mode of at least one subunit of the device from the active mode to the sleep mode if the time measurement exceeds a threshold value preset for the time measurement.

33. The device of claim 17, wherein one subunit of the device, a first subunit, is an acceleration measurement system for measuring the movement of the device, the acceleration measurement system comprising a movement identification part active in the sleep mode and an acceleration measurement part active in the active mode.

34. The device of claim 33, wherein one subsystem of the device, a second subunit, is a main system of the device.

35. The device of claim 34, wherein the acceleration measurement system is configured to transfer, in the sleep mode, measurement results of the movement to the main system, and the control means located in the main system are configured to control the transfer of the main system and/or the acceleration measurement system from the sleep mode to the active mode.

36. The device of claim 34, wherein the control means belonging to the main system are configured to control changes in the operation mode of the main system and/or the acceleration measurement system.

37. The device of claim 34, wherein the control means belonging to the acceleration measurement system are configured to control changes in the operation mode of the main system and/or the acceleration measurement system.

38. The device of claim 34, wherein the device comprises means for estimating the movement, the estimation means being located in the acceleration measurement system.

39. The device of claim 34, wherein the device comprises means for estimating the movement, the estimation means being located in the main system.

40. The device of claim 17, wherein the device is a mobile phone or auxiliary equipment thereof either fixedly or wirelessly connected to the mobile phone.
